(19) United States
(12) Patent Application Publication
(10) Pub. No.: US 2012/0182841 A1
(43) Pub. Date: Jul. 19, 2012

(54) TIMEPIECE

(75) Inventor: Daniel DE BELDER, Essen (BE)

(73) Assignee: DIAMOND TRADING, NAAMLOZE VENNOOTSCHAP, Antwerpen 1 (BE)

(21) Appl. No.: 13/343,097

(22) Filed: Jan. 4, 2012

(30) Foreign Application Priority Data
Jan. 14, 2011 (BE) 2011/0014

(51) Int. Cl. G04C 17/02

(52) U.S. Cl. 368/240

(57) ABSTRACT

Timepiece, characterised in that it primarily consists of a baseplate (3) with at least a series of small lights (4) on it to indicate the hour and a series of small lights (4) to indicate the minutes, and an electrical or electronic controller (9) to control the lights to indicate the hour and minutes.

The present invention relates to a timepiece.

An analogue timepiece with a dial and at least two hands that are secured to a central shaft protruding through the centre of the dial is already known.

The hands are driven via the central shaft by a mechanism, whereby the two hands execute a circular movement above the dial.

One hand hereby makes one revolution every 12 hours and is called the hour hand. The hour hand moves along 12 marks in a circle on the dial. The aforementioned marks indicate the whole hours and are implemented as figures, small lines and/or other symbols.

The other hand makes one revolution every hour and is called the minute hand. This hand indicates the minutes that are often marked with extra marks, generally small lines, on the dial.

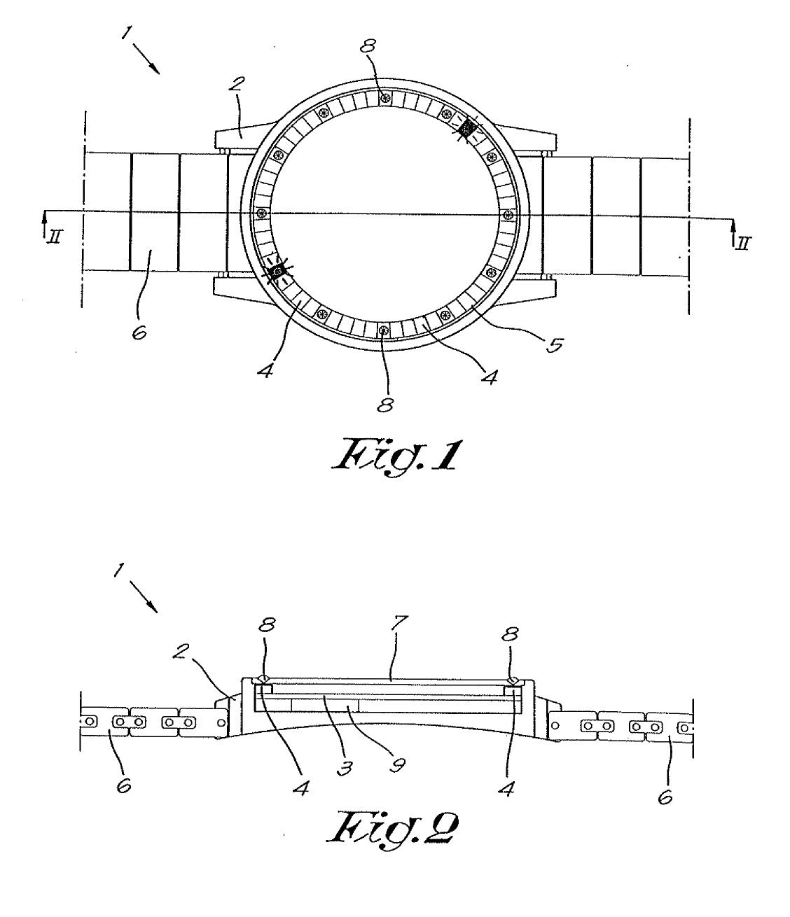

A digital timepiece is also known in which the hours and minutes are indicated as figures on a display. The hours are displayed as figures from 0 to 23 inclusive, or as figures from 1 to 12 inclusive. The minutes, and if applicable also the seconds, are indicated as FIGS. 0 to 59 inclusive.

As is known, a timepiece draws its energy from a mechanical or electrical source. A mechanical source is a weight or a spring. An electrical source can be (storage) batteries or solar cells.

A disadvantage of existing timepieces is that they are difficult or impossible to read in the dark.

The use of such timepieces in the dark is only possible if, in a known way, it is constructed with lighting means.

A disadvantage of this is that the aforementioned lighting means must be activated before it produces light, which is not easy in a dark environment.

Having the light on continuously is certainly not suitable with wristwatches, as the power source that provides the timepiece with power would be used up far too quickly.

A disadvantage of digital timepieces is that they cannot always be easily read, for example because sunlight shines on the display, or because the figures in some models turn out to be relatively small.

The purpose of the present invention is to provide a solution to one of the aforementioned and/or other disadvantages and to present an alternative embodiment for the conventional analogue or digital timepieces.

To this end the invention concerns a timepiece that primarily consists of a baseplate with at least a series of small lights on it to indicate the hour and a series of small lights to indicate the minutes, and an electrical or electronic controller to control the lights to indicate the hour and minutes.

An advantage of a timepiece according to the invention is that such a timepiece can be clearly read in the dark.

Another advantage is that a timepiece according to the invention does not need to be equipped with lighting means in order to read the entire dial in the dark, but it is sufficient to provide very small local lights that require little energy.

A timepiece according to the invention consists of a minimal number of moving parts, and this is in contrast to the conventional mechanical timepieces. This provides the advantage that such a timepiece requires less maintenance and exhibits no wear and tear.

According to a preferred characteristic of the invention, the series of small lights for the hours, and the series of small lights for the minutes are spread over the circumference of a ring, respectively a ring for the hours and a ring for the minutes.

Preferably the series of lights of the hour ring and the series of lights of the minute ring are spread evenly over the circumference of the ring, and twelve small lights are used to indicate the hours and sixty small lights to indicate the minutes.

An advantage of this is that such a timepiece comes across as familiar as it can be read in the same way as a traditional analogue timepiece with hands.

According to another preferred characteristic of the invention, the small lights are constructed in the form of light emitting diodes or LED's.

An advantage of this is that LED's consume little energy and have a long lifetime.

An additional advantage of the use of LED's is that the light scattering is minimal and the light pollution remains limited.

With the intention of better showing the characteristics of the invention, a preferred embodiment of a timepiece according to the invention is described hereinafter by way of an example, without any limiting nature, with reference to the accompanying drawings, wherein:

FIG. 1 schematically shows a top view of a timepiece according to the invention;

FIG. 2 shows a cross-section according to line II-II of FIG. 1;

FIG. 1 shows a timepiece 1, which in this case is constructed in the form of a wristwatch. The timepiece 1 consists of a housing 2 with a baseplate 3 with a series of small lights 4 on it that are spread over the circumference of a ring 5, in this case a circular ring. Furthermore, a wrist strap 6 is attached to the housing, whereby the timepiece 1 can be worn around the wrist.

In a more general embodiment of a timepiece according to the invention a number of series of small lights 4 are placed on the baseplate, respectively a series of small lights 4 to indicate the hours and a series of small lights 4 to indicate the minutes. If applicable the timepiece 1 can be extended with one or more additional series of small lights 4 to indicate the day, phase of the moon and similar.

In such a more general embodiment, the series of small lights 4 for the hours, and the series of small lights 4 for the minutes, are spread over the circumference of a ring 5, respectively a ring 5 for the hours and a ring 5 for the minutes.

In the embodiment of FIG. 1, the hour ring 5 and the minute ring 5 are the same. On this one ring 5 there are a total of 60 small lights 4, which in this embodiment are in the form of LED's.

In this embodiment the total of 60 small lights 4 of the timepiece 1 are evenly spread over the circumference of the ring 5.

As illustrated in FIG. 2 the small lights 4 are covered by a cover glass 7 that is secured to the housing 2 of the timepiece 1 and is preferably made from synthetic diamond.

In this case ground jewels 8 are incorporated in the aforementioned cover glass 7 whereby the jewels 8 are placed in the position of the lights 4, for example in the position of the hours as illustrated in FIG. 1. It is of course not excluded that such jewels 8, preferably jewels in the form of fluorescent diamonds, are for example only shown at the quarter hours or at the minutes or similar.

FIG. 2 further shows that the timepiece 1 has a controller 9 that it is positioned under the baseplate 3 in the housing 2.

The operation of the timepiece 1 according to the invention is simple and as follows.

At all times one small light 4 of the ring 5 is lit at the position that the hour hand of a conventional analogue timepiece would indicate, and this to identify the whole hours.

At the same time one small light 4 of the ring 5 is lit at the position that the minute hand of a conventional analogue timepiece would indicate, and this to identify the minutes.

Consequently a timepiece 1 according to the invention can be read in the same way as a conventional analogue timepiece, with the difference that the time is not indicated by an hour and minute hand, but by the small light 4 concerned lighting up.

In order to improve the readability of the timepiece 1, according to the invention, the small lights 4 are made from multicoloured LED's or LED's that can light up with a different intensity. In this way the small light 4 of the ring 5 takes on a different colour or intensity, depending on whether it indicates hours or minutes.

For example the LED's can be a red colour to indicate the hours and a blue colour to indicate the minutes. The user can then read the timepiece 1 at a glance.

When the jewels 8 are fluorescent diamonds, they provide a nice aesthetic effect when they are illuminated by the LED's and also result in better readability.

According to the invention it is also possible to use ultraviolet fluorescent diamonds in the timepiece 1, and this in combination with ultraviolet LED's.

The LED's of the timepiece 1 are controlled by the controller 9, which is under the baseplate 3. This controller 9 draws its energy from a battery that is not shown in the drawings.

Instead of using a single ring 5 that can be used for the hours and the minutes, another possibility according to the invention consists of providing two rings that each act separately as a ring for the hours on the one part and a ring for the minutes on the other. The rings do not necessarily need to be circular, but can also take on another shape such as an oval, a rectangle, a star shape or similar.

According to an alternative embodiment, the lights do not even need to be on a ring, but can for example be arranged as a bow or straight line.

The present invention is by no means limited to the embodiment described as an example and shown in the drawings, but a timepiece according to the invention can be realised in all kinds of variants, without departing from the scope of the invention.

1. Timepiece, characterised in that it primarily consists of a baseplate (3) with at least a series of small lights (4) on it to indicate the hour and a series of small lights (4) to indicate the minutes, and an electrical or electronic controller (9) to control the lights to indicate the hour and minutes.

2. Timepiece according to claim 1, characterised in that the series of small lights (4) for the hours, and the series of small lights (4) for the minutes are spread over the circumference of a ring (5), respectively a ring (5) for the hours and a ring (5) for the minutes.

3. Timepiece according to claim 2, characterised in that the series of small lights (4) of the ring (5) for the hours and the series of small lights (4) of the ring (5) for the minutes are spread evenly over the circumference of the ring (5).

4. Timepiece according to claim 2, characterised in that the ring (5) or rings are circular.

5. Timepiece according to claim 1, characterised in that there are twelve small lights (4) to indicate the hours and sixty small lights (4) to indicate the minutes.

6. Timepiece according to claim 1, characterised in that the small lights (4) are in the form of light emitting diodes or LED's.

7. Timepiece according to claim 1, characterised in that the ring (5) for the hours and the ring (5) for the minutes are the same and the small lights (4) of this ring (5) are used to indicate both the hours and minutes.

8. Timepiece according to claim 1, characterised in that the small lights (4) are multicoloured LED's or LED's that can be controlled at a different intensity, and which take on a different colour or light intensity depending on whether they indicate hours or minutes.

9. Timepiece according to claim 1, characterised in that the small lights (4) are covered by a cover glass (7).

10. Timepiece according to claim 9, characterised in that the cover glass (7) is made from synthetic diamond.

11. Timepiece according to claim 9, characterised in that ground jewels (8) are incorporated in the cover glass (7) in the position of the small lights (4) for the hours and/or the small lights (4) for the minutes.

12. Timepiece according to claim 11, characterised in that the ground jewels (8) are fluorescent diamonds.

13. Timepiece according to 11, characterised in that the small lights (4) are in the form of ultraviolet LED's and the ground jewels (8) are ultraviolet fluorescent diamonds.

14. Timepiece according to claim 1, characterised in that the timepiece (1) is a wristwatch.

15. Timepiece according to claim 1, characterised in that the baseplate (3) is built into a housing (2) of the timepiece (1).

16. Timepiece according to claim 10, characterised in that ground jewels (8) are incorporated in the cover glass (7) in the position of the small lights (4) for the hours and/or the small lights (4) for the minutes.
